(19) United States
(12) Patent Application Publication
(10) Pub. No.: US 2015/0312369 A1
(43) Pub. Date: Oct. 29, 2015

(54) CHECKPOINTS FOR MEDIA BUFFERING

(71) Applicant: INTEL CORPORATION, SANTA CLARA, CA (US)

(72) Inventors: Thomas A. Birch, Portland, OR (US); Joseph G. Warner, Tempe, AZ (US)

(21) Appl. No.: 14/127,949

(22) PCT Filed: Jun. 26, 2013
(86) PCT No.: PCT/US2013/047953

§ 371 Date: Nov. 21, 2014

(51) Int. Cl. H04L 29/08; G06F 17/30; H04L 29/06

(52) U.S. Cl. CPC H04L 67/2847; H04L 65/60; G06F 17/30132

(57) ABSTRACT

Embodiments of techniques, apparatuses and systems associated with media playback are disclosed. In some embodiments, a computing device may receive information about a media file, the information representative of one or more of a plurality of elapsed time points corresponding to buffer checkpoints in playback of the media file. The computing device may determine an amount of the media file that has been cached in a buffer, and may determine, prior to commencing playback of a portion of the media file between two of the elapsed time points, whether the cached amount includes the portion. In response to determining that the cached amount does not include the portion, the computing device may increase the cached amount to include the portion before commencing playback of the portion. Other embodiments may be described and/or claimed.

### TECHNICAL FIELD

The present disclosure relates generally to the field of media delivery, and more particularly, to media buffering.

### BACKGROUND

When a user of a computing device requests the delivery of a media file (e.g., an audio or video file) across a communication network, the computing device often receives the file as a stream of data and caches the data in a buffer until a sufficient amount of the data has been received to commence playback. The amount cached at the beginning of playback is typically less than the entire file, and thus the computing device may continue to buffer the file during playback (often at a slower buffer rate during playback). When the amount of the file played back exceeds the amount cached, playback is interrupted until the computing device buffers a sufficient amount to resume playback. These interruptions result in “choppy” playback that may create a disjointed and unpleasant user experience.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 depicts a media file including buffer checkpoint information, in accordance with various embodiments.

FIG. 2 is a block diagram of an illustrative computing device configured for various media buffer checkpoint operations, in accordance with various embodiments.

FIG. 3 is a flow diagram of an illustrative process for playing a media file including buffer checkpoint information, in accordance with various embodiments.

FIG. 4 depicts an illustrative display that may be provided by a computing device during playback of a media file with buffer checkpoints, in accordance with various embodiments.

FIG. 5 is a flow diagram of an illustrative process for annotating a media file with buffer checkpoints for use during playback, in accordance with various embodiments.

FIG. 6 depicts an illustrative display that may be provided by a computing device during annotation of a media file with buffer checkpoint information, in accordance with various embodiments.

### DETAILED DESCRIPTION

Embodiments of techniques, apparatuses and systems associated with media playback are disclosed. In some embodiments, a computing device may receive information about a media file, the information representative of one or more of a plurality of elapsed time points corresponding to buffer checkpoints in playback of the media file. The computing device may determine an amount of the media file that has been cached in a buffer, and may determine, prior to commencing playback of a portion of the media file between two of the elapsed time points, whether the cached amount includes the portion (e.g., whether the portion is capable of playback in its entirety from the cached amount). In response to determining that the cached amount does not include the portion, the computing device may increase the cached amount to include the portion before commencing playback of the portion (e.g., by continuing to cache additional data). The techniques, apparatuses and systems disclosed herein may significantly improve the viewer experience by allowing media creators to limit buffering operations to natural pause points in the media (e.g., the ends of sentences or scene transitions), thereby avoiding random buffering disruptions. In some embodiments, the viewer can anticipate when buffering will occur, thus avoiding the jarring interruption of playback, and can retain the flow of the media content (e.g., a story line or conversation) instead of losing track of what occurred before buffering began.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

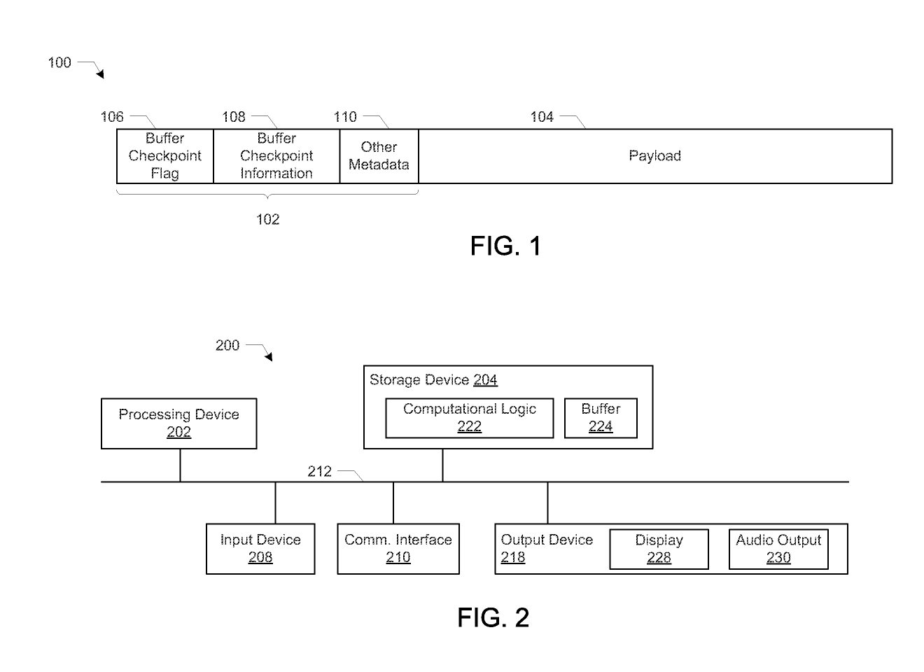

FIG. 1 depicts a media file 100 including buffer checkpoint information 108 in a header 102 of the media file 100, in accordance with various embodiments. In some embodiments, the buffer checkpoint information 108 may include information representative of one or more elapsed time points of a plurality of elapsed time points corresponding to buffer checkpoints in playback of the media file 100. An elapsed time point may be a point in time at which a computing device (such as the computing device 200 of FIG. 2, discussed below) may check the amount of the media file 100 stored in a buffer to determine whether or not the buffer includes the portion of the media file 100 between the elapsed time point and a next elapsed time point of the plurality of elapsed time points. The information representative of one or more elapsed time points may be presented as a list of timestamps representative of times measured from the beginning of the media file, a list of time intervals between buffer checkpoints, a list of image frame indices measured from the beginning of the media files, or a list of the number of image frames between buffer checkpoints, for example.

The buffer checkpoint information 108 may be included in a portion of the header 102 designated (e.g., by a video standard) for buffer checkpoint information, and/or the buffer checkpoint information 108 may be included in a customizable or otherwise available portion of the header 102. In some embodiments, a device that receives the buffer checkpoint information 108 (such as the computing device 200, discussed below) may add additional buffer checkpoints to the one or more included in the buffer checkpoint information 108 (e.g., a buffer checkpoint at the start of the media file 100 and/or a buffer checkpoint at the end of the media file 100). In some embodiments, these start and end buffer checkpoints may be explicitly listed in the elapsed time points included in the buffer checkpoint information 108.

In some embodiments, the header 102 may also include a buffer checkpoint flag 106. The buffer checkpoint flag 106 may be a binary or other value that signals to a computing device that the media file 100 includes buffer checkpoint information. In some embodiments, a computing device (such as the computing device 200 of FIG. 2) may determine the value of the buffer checkpoint flag 106 upon receipt of the media file 100. If the buffer checkpoint flag 106 indicates that the media file 100 includes buffer checkpoint information 108, the computing device may identify and process the buffer checkpoint information 108 from the header 102, and may buffer the media file 100 in accordance with the buffer checkpoint information 108. If the buffer checkpoint flag 106 does not indicate that the media file 100 includes buffer checkpoint information 108, the computing device may buffer the media file 100 in accordance with a default buffering routine (examples of which are discussed below).

In some embodiments, buffer checkpoint information about the media file 100 may not be included in a header 102 of the media file 100, but may be encoded in the payload 104 of the media file 100 or communicated to a computing device separately from the media file 100. As shown in FIG. 1, the header 102 of the media file 100 may also include other metadata 110 about the media file 100 (e.g., title, author, video and/or audio resolution, etc.). In some embodiments, the header 102 and the payload 104 may be encoded using a High Efficiency Video Coding (HEVC) video compression standard, such as H.265.

Referring now to FIG. 2, a computing device 200 configured for various media buffer checkpoint operations is illustrated, in accordance with various embodiments. The computing device 200 may include, or be part of, any of a number of computing systems, such as a desktop computer, a portable computer, a mobile communications device, a tablet computer, a server, a client, a thin client, a cellular telephone, wearable device, or a smartphone, for example. In some embodiments, the computing device 200 may include, or be part of, a digital video recorder (DVR). The computing device 200 may be configured for buffering media files (such as the media file 100 of FIG. 1) in accordance with the techniques disclosed herein, and/or may be configured for annotating media files with buffer checkpoints (e.g., to provide a media file such as the media file 100 of FIG. 1) in accordance with the techniques disclosed herein. In some embodiments, the computing device 200 may be a client computing device that receives media content (e.g., the media file 100) from a content distribution device (e.g., a home content distribution device). For example, the computing device 200 may be a “thin” client configured to receive the media file 100 from a home content server.

A user operating the computing device 200 for buffering media files may be referred to herein as a “viewer,” while a user operating the computing device 200 for annotating media files with buffer checkpoints may be referred to herein as a “creator.” These labels are used simply for convenience and clarity; any user may be a viewer, a creator, or both. Additionally, the operations of the computing device 200 may be discussed with reference to the media file 100 of FIG. 1, but the computing device 200 may analogously process other forms of media files annotated with or otherwise accompanied by buffer checkpoint information in accordance with embodiments disclosed herein.

As shown, the computing device 200 may include an input device 208, which may include one or more input devices (e.g., a keyboard, cursor control devices such as a mouse, a touchpad, a stylus, a microphone, a Global Positioning System (GPS) receiver, a camera, a media streaming input interface, a cable and/or satellite connection, an accelerometer, and/or a motion detector, for example). In some embodiments, a user of the computing device 200 may operate the input device 208 to initiate a request for playback of the media file 100 (e.g., by clicking an Internet link with a mouse, by using a computer application, downloadable application or widget that provides streaming media, or by opening a file stored locally to the computing device 200 for example). In some embodiments, a creator may operate the input device 208 to select one or more buffer checkpoints for a media file, as discussed in further detail below.

The computing device 200 may include an output device 218, which may include one or more output devices (e.g., a projector and/or a printer). In some embodiments, the output device 218 may include a display device 228 (e.g., a flat panel display, an LCD display, a projector, a touch screen display, a high speed digital video interface, and/or a computer monitor) and/or an audio output device 230 (e.g., one or more speakers or other audio transducers). A media file having image content may be played back using the display device 228, and a media file having audio content may be played back using the audio output device 230; multimedia files may be played back using any suitable number and type of output device included in the output device 218.

The computing device 200 may include a communication interface 210, which may include hardware configured for wireless and/or wired communication (such as network interface cards, modems, WiFi devices, Bluetooth devices, and so forth). In some embodiments, the communication interface 210 may receive information about the media file 100 from a remote source (e.g., through a computer or other communications network). For example, in embodiments in which the computing device 200 includes or is included in a DVR, the remote source may be one or more digital media providers. In embodiments in which the computing device 200 is a client device in a home content distribution system, the remote source may be the home content distribution device. The rate at which the communication interface 210 receives information about the media file 100 may be limited by rate at which the remote source can supply the information, the bandwidth of the data pipeline supplying data to the communication interface, and/or the hardware and/or software with which the communication interface 210 is configured, among others. In some embodiments, a media file received at the computing device 200 (via the communication interface 210) may include buffer checkpoint information.

The computing device 200 may also include a processing device 202 and a storage device 204. The processing device 202 may include one or more processing devices, such as one or more processing cores, System on Chips (SOCs), Application Specific Integrated Circuits (ASICs), electronic circuits, processors (shared, dedicated, or group), combinational logic circuits, and/or other suitable components that may be configured to process electronic data. The storage device 204 may include any suitable memory or mass storage devices (such as solid-state drive, diskette, hard drive, compact disc read only memory (CD-ROM) and so forth). The components of the computing device 200 may be coupled to each other via a system bus 212, which may represent one or more buses. In some embodiments, portions of the device 200 may be embodied in an SOC. In embodiments in which the system bus 212 includes multiple buses, the multiple buses may be bridged by one or more bus bridges (not shown).

The storage device 204 may include a buffer 224. The buffer 224 may be a memory or a section of memory configured to store information about a media file as it is received at the computing device 200 via the communication interface 210. In some embodiments, the buffer 224 may have a fixed capacity, and may shift data in as the data is received and out as the data is no longer needed (e.g., when the data has already been used for playback). In some embodiments, the processing device 202 may be configured to cause the playback of the media file when various conditions are met regarding the amount of the media file cached in the buffer, as discussed below. In some embodiments, the processing device 202 may be configured to annotate a media file with buffer checkpoint information, as discussed below.

The storage device 204 may include a set of computational logic 222. The computational logic 222 may include one or more copies of computer readable media having instructions stored therein which, when executed by the processing device 202, cause the computing device 200 to implement any of the techniques and methods disclosed herein, or any portion thereof. For example, in some embodiments, the processing device 202 may execute the computational logic 222 to run a media player application that causes the computing device 200 to buffer a media file including buffer checkpoint information, and/or run a media editor application that causes the computing device 200 to annotate a media file with buffer checkpoint information, among other operations.

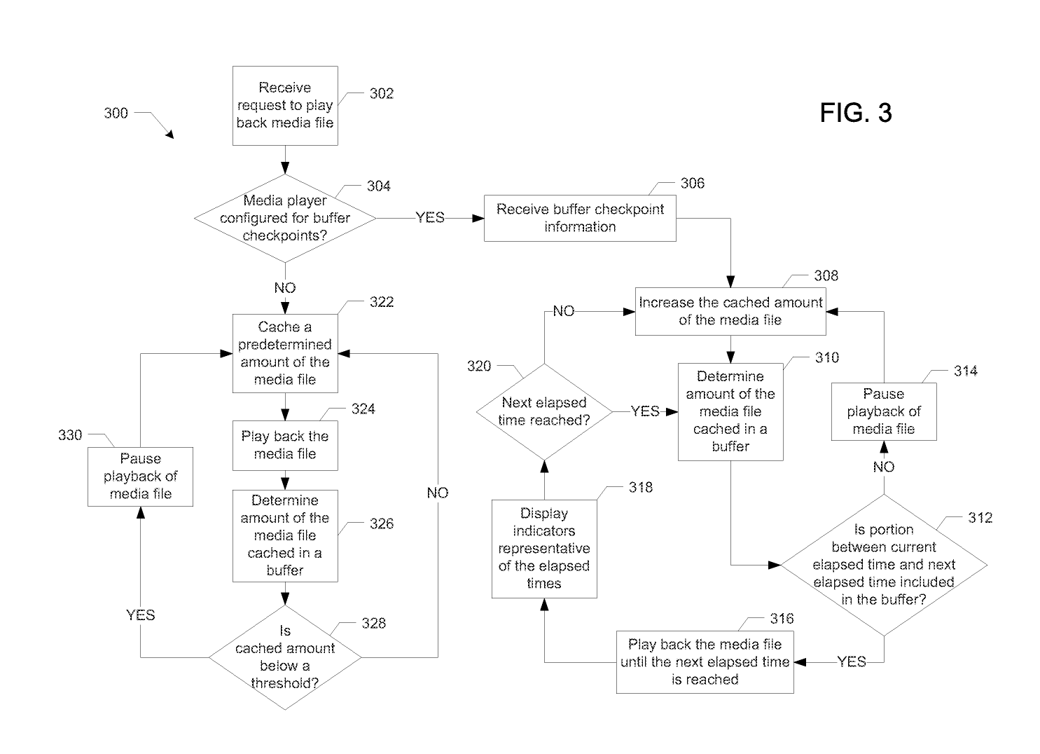

Referring now to FIG. 3, a flow diagram is provided of an illustrative process 300 for playing a media file including buffer checkpoint information, in accordance with various embodiments. It may be recognized that, while the operations of the process 300 (and the other processes described herein) are arranged in a particular order and illustrated once each, in various embodiments, one or more of the operations may be repeated, omitted or performed out of order. For illustrative purposes, operations of the process 300 may be described as performed by the computing device 200 with reference to the media file 100, but the operations of the process 300, including individual operations of the process 300, may be performed by any suitably configured computing device or collection of computing devices.

The process 300 may begin at the operation 302, in which the computing device 200 may receive a request to play back the media file 100. In some embodiments, this request may be received from a viewer via the input device 208.

At the operation 304, the computing device 200 may determine whether a media player application or other programming is configured to recognize and process buffer checkpoint information. In some embodiments of the operation 304, the computing device 200 may determine that a value of the buffer checkpoint flag 106 indicates that the media file 100 includes buffer checkpoint information 108, and in response, may evaluate the capabilities of the media player application or other programming to determine if the computing device 200 is configured to use the buffer checkpoint information 108 in buffering the media file 100.

If the computing device 200 determines at the operation 304 that buffer checkpoint information may be recognized and processed, the computing device 200 may proceed to the operation 306 and receive the buffer checkpoint information 108. In some embodiments, the operation 304 includes receiving information representative of one or more elapsed time points corresponding to buffer checkpoints in playback of the media file 100. In some embodiments, the information representative of one or more elapsed time points may include a list of one or more timestamps corresponding to the buffer checkpoints. As discussed above with reference to FIG. 1, the computing device 200 may add additional buffer checkpoints to the elapsed time points provided in the buffer checkpoint information 108; for example, the computing device 200 may add a buffer checkpoint corresponding to the start time of the media file 100 and the end time of the media file 100.

At the operation 308, the computing device 200 may increase the amount of the media file 100 cached in the buffer 224. The operation 308 may continue during the subsequent operations (e.g., the operations 310-320). In some embodiments, the rate at which the media file 100 is cached may decrease while the computing device 200 performs other operations (e.g., when the processing device 202 approaches its maximum processing capacity or when network bandwidth is significantly reduced during playback).

At the operation 310, the computing device 200 may determine an amount of the media file 100 cached in the buffer 224. In some embodiments, the processing device 202 may query the buffer 224 or other memory location to determine the amount of the media file 100 cached in the buffer 224. In some embodiments of the operation 310, the computing device 200 may determine how much of the media file 100 may be played back with the data cached in the buffer 224. For example, the computing device 200 may determine that, when the media file 100 has not yet commenced playback, the amount of the media file 100 cached in the buffer is sufficient to play back the media file 100 up to the time point 03:37.

At the operation 312, the computing device 200 may determine whether the amount of the media file 100 cached in the buffer 224 includes a portion of the media file 100 between a current one of the buffer checkpoints and a next one of the buffer checkpoints. As used herein, a “current” buffer checkpoint may refer to a buffer checkpoint that corresponds to an elapsed time point of the list of elapsed time points (which may be referred to as the “current elapsed time point”) equal to or closest in the future to the current time of playback. For example, if the list of elapsed time points includes 00:00, 03:30, 04:45 and 05:12, the “current” elapsed time when no playback of the media file 100 has yet occurred (i.e., the current time of playback is 00:00) is 00:00. As used herein, a “next” buffer checkpoint may refer to a buffer checkpoint that corresponds to an elapsed time point of the list of elapsed time points (which may be referred to as the “next” elapsed time point”) following the elapsed time point corresponding to the current buffer checkpoint.

For example, if the list of elapsed time points includes 03:30, 04:45 and 05:12, the “next” elapsed time point when no playback of the media file 100 has yet occurred is 03:30. If 04:52 of the media file 100 has been played back, the “next” elapsed time point is 05:12. If 05:20 of the media file 100 has been played back, the “next” elapsed time point may be a time representative of the end of the media file 100. As discussed above, such an elapsed time point may be explicitly included in the buffer checkpoint information 108, or the computing device 200 may be configured to treat the end time as a buffer checkpoint. Continuing with the example discussed above, when no playback of the media file 100 has yet occurred, and when the amount of the media file 100 cached in the buffer includes the portion of the media file 100 between 00:00 and 03:37 (e.g., as determined at the operation 310), the computing device 200 may determine that 03:37 meets or exceeds the first buffer checkpoint at 03:30, and thus that the amount of the media file 100 cached in the buffer 224 includes the portion of the media file 100 between the current buffer checkpoint and the next buffer checkpoint.

If the computing device 200 determines at the operation 312 that the amount of the media file 100 cached in the buffer 224 does not include the portion of the media file 100 between the current elapsed time point and the next elapsed time point, the computing device 200 may pause the playback of the media file 100 at the operation 314 and continue to increase the amount of the media file 100 cached in the buffer 224, at operation 308. As used herein, the term “pause” may refer to stopping playback currently in progress and/or to waiting to initiate playback.

If the computing device 200 determines at the operation 312 that the amount of the media file 100 cached in the buffer 224 includes the portion of the media file 100 between the current elapsed time point and the next elapsed time point, the computing device 200 may play back the media file 100 until the next elapsed time point is reached in the playback (i.e., the computing device 200 may play back the portion of the media file 100 between the current elapsed time point and the next elapsed time point). Continuing the above example, if no playback of the media file 100 has yet occurred, and if the computing device determined at the operations 310 and 312 that the amount of the media file cached in the buffer is sufficient to play back the media file 100 up to the 03:30 buffer checkpoint, the computing device 200 may playback the portion of the media file 100 between 00:00 and 03:30.

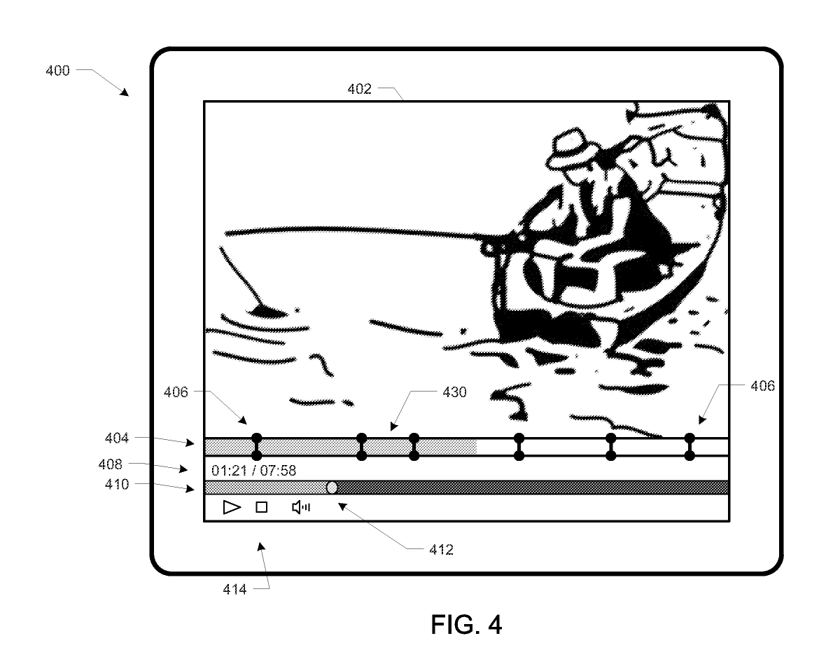

In some embodiments, the computing device 200 may display (e.g., with the display device 228), during playback of the media file 100, one or more indicators of the elapsed time points corresponding to the buffer breakpoints at the operation 318. An illustrative display including such indicators is discussed below with reference to FIG. 4. In some embodiments, the computing device 200 may not display such indicators during playback of the media file 100, and thus the operation 318 may not be performed.

At the operation 320, the computing device 200 may determine whether playback of the media file 100 has reached the next elapsed time point (i.e., if the portion of the media file 100 between the current elapsed time point and the next elapsed time point has completed). If the next elapsed time point has not been reached, the computing device 200 may continue to playback the media file 100 and may also continue to increase the amount of the media file cached in the buffer 224 per the operation 308. If the computing device determines at the operation 320 that the elapsed time point has been reached, the computing device 200 may proceed to the operation 310 and determine the amount of the media file 100 that is cached in the buffer 224. This process may continue, with the computing device only proceeding with playback of the media file 100, once a buffer checkpoint is reached, when sufficient data has been cached to ensure that playback can proceed without interruption until the next buffer checkpoint.

Returning to the operation 304, if the computing device 200 determines at the operation 304 that the media player or other programming is not configured for buffer checkpoints (and thus that buffer checkpoint information may not be recognized and processed), the computing device 200 may execute a default buffering routine that does not utilize buffer checkpoint information 108. In some embodiments, the operation 304 may include a determination that a media file requested at the operation 302 does not include any buffer checkpoint information; in response to such a determination, the computing device 200 may execute the default buffering routine.

The operations 322-330 provide an illustrative embodiment of one such default routine, but other buffering routines that do not utilize buffer checkpoint information may be used. At the operation 322, the computing device 200 may cache a predetermined amount of the requested media file 100 for playback to commence. In some embodiments, the predetermined amount may be a specified percentage of the media file 100, and/or a specified amount of playback time (e.g., five seconds). At the operation 324, the computing device 200 may playback the media file 100. At the operation 326, the computing device 200 may determine the amount of the media file 100 cached in the buffer 224 (e.g., as discussed above with reference to the operation 310). If the computing device 200 determines at the operation 328 that the cached amount is below a threshold (e.g., a percentage or playback time threshold as discussed above), the computing device 200 may pause playback of the media file 100 at the operation 230 and proceed to the operation 322 to buffer sufficient video for playback to resume. If the computing device 200 determines at the operation 328 that the cached amount exceeds the threshold, the computing device 200 may continue to the operation 322 and continue to buffer while playback continues.

FIG. 4 depicts an illustrative display 400 that may be provided by the computing device 200 (e.g., via the display device 228) during playback of the media file 100, in accordance with various embodiments. The display 400 may include a video or other image 402 associated with the media file 100, a playback indicator bar 410 including a current time indicator 412 to reflect the progress of playback of the media file 100, a current time/duration indicator 408, and a control bar 414 that may include one or more media control icons (e.g., play, stop, pause, and volume controls, for example). The display 400 may also include a buffer checkpoint indicator bar 404, which may provide one or more buffer checkpoint indicators 406. The buffer checkpoint indicators 406 may be positioned along the buffer checkpoint indicator bar 404 and aligned with various points on the playback indicator bar 410 to indicate the elapsed time points at which buffer checkpoints are included with the media file 100. In some embodiments, the amount of the media file 100 cached in the buffer 224 may also be represented (e.g., as a shaded bar 430 similar to the playback indicator bar 410) along the buffer checkpoint indicator bar 404. The display 400 may also provide a “buffering” message or indicator (not shown) when the media file 100 is paused for buffering during playback.

Various features of the display 400 of FIG. 4 provide a number of advantages; for example, a viewer of the media file 100 in the display 400 will know when pauses in playback may occur (if necessary), and can anticipate them. Because many viewers do not have access to high bandwidth computing devices and/or networks, and thus cannot buffer media fast enough to avoid buffering pauses during playback, the techniques disclosed herein may be applied to significantly improve the quality of such viewers' media experience.

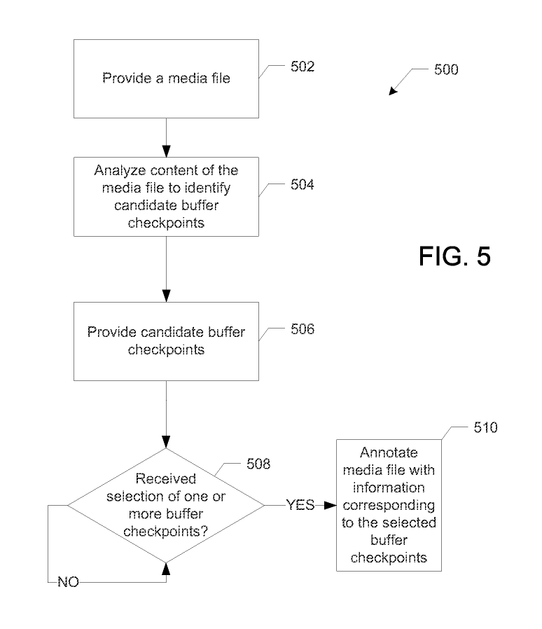

Referring now to FIG. 5, a flow diagram is provided of an illustrative process 500 for annotating a media file with buffer checkpoints for use during playback, in accordance with various embodiments. For illustrative purposes, operations of the process 500 may be described as performed by the computing device 200 with reference to the media file 100, but the operations of the process 500, including individual operations of the process 500, may be performed by any suitably configured computing device or collection of computing devices.

The process 500 may begin at the operation 502, in which the computing device 200 may provide the media file 100. The media file 100 may be stored locally to the computing device 200 (e.g., in local storage of the storage device 204) or remotely from the computing device 200. In some embodiments, the operation 502 may include displaying the media file 100 (e.g., on the display device 228 and/or the audio output device 230).

At the operation 504, the computing device 200 may analyze content of the media file 100 to identify one or more candidate buffer checkpoints for the media file 100. The content analyzed at the operation 504 may include audio content of the media file 100, video content of the media file 100, textual content of the media file 100, and/or any other available content of the media file 100. The analysis performed at the operation 504 may include natural language processing, video processing, audio processing or other known processing techniques for identifying candidate buffer checkpoints in the media file 100. The analysis performed at the operation 504 may include, for example, identification of pauses in dialogue, the ends of sentences (spoken or in written text), scene changes (e.g., fades and transitions), page changes, changes in topic, intermissions, and track changes (e.g., when the media file 100 represents an album of musical songs), among others.

The computing device 200 may perform one or more different types of analysis at the operation 504 to return a candidate list of buffer checkpoints. In some embodiments, the computing device 200 may analyze fewer than all of the types of content available in the media file 100; for example, when the media file 100 is a video file having image and audio content, the computing device 200 may only analyze the audio content at the operation 504 (e.g., for fades in the music, indicating scene changes) and not analyze the image content. In some embodiments, the computing device 200 may include additional factors in the analysis performed at the operation 504. For example, the computing device 200 may be configured to preferentially weight candidate checkpoints that are evenly distributed through the duration of the media file 100, to identify a minimum or maximum number of candidate checkpoints, or to preferentially weight candidate checkpoints that are spaced in accordance with the average or media buffer length of the viewer devices expected to be receiving the media file 100. By performing the analysis of the operation 504, the computing device 200 may assist a creator in annotating the media file 100 with buffer checkpoint information 108, which may improve the speed and accuracy of media file creation.

At the operation 506, the computing device 200 may provide the candidate buffer checkpoints (identified at the operation 504). In some embodiments, the candidate buffer checkpoints may be provided to the display device 228 for display to the creator in the form of a list of elapsed time points or other indicators. In some embodiments, the candidate buffer checkpoints may be provided to a printer or other output device 218.

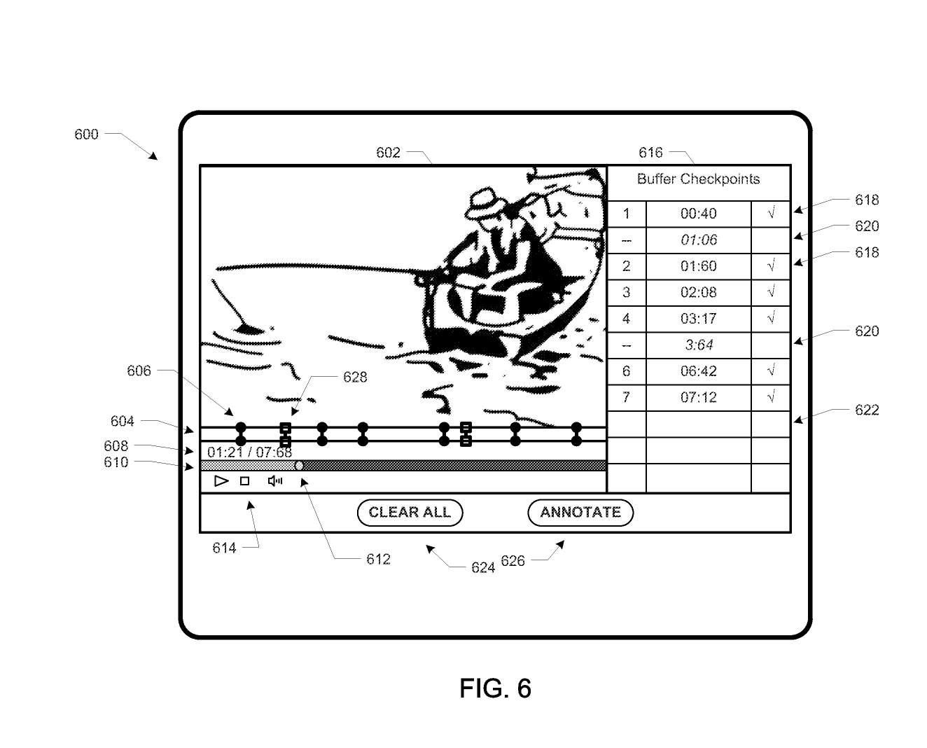

At the operation 508, the computing device 200 may determine whether it has received a selection of one or more buffer checkpoints for use in annotating the media file 100. In some embodiments, a selection received at the operation 508 may be received from a creator via the input device 208. For example, a creator may use a mouse or touchscreen to select one of the candidate buffer checkpoints (provided at the operation 506) from a list of candidate buffer checkpoints displayed on the display device 228. In another example, a creator may use a keyboard or other text input device to type in an elapsed time point that is to correspond to a buffer checkpoint. In another example, a creator may use a mouse or touchscreen to select a particular location along a buffer checkpoint indicator bar (as discussed below with reference to FIG. 6), the location corresponding to an elapsed time point which is to serve as a buffer checkpoint. Any one of more such selection techniques may be used by the computing device 200 to determine whether a selection of one or more buffer checkpoints has been received at the operation 508.

If the computing device 200 determines that no selection has been received at the operation 508, the computing device 200 may wait for such a selection or for an exit command to end the process 500. If the computing device 200 determines that a selection of one or more buffer checkpoints has been received at the operation 508, the computing device 200 may proceed to execute the operation 510 and annotate the media file with information corresponding to the selected buffer checkpoints. As discussed above, in some embodiments, the information corresponding to the selected buffer checkpoints may be information representative of elapsed time points corresponding to buffer checkpoints in playback of the media file 100. In some embodiments, the information representative of elapsed time points may include timestamps corresponding to the buffer checkpoints. The annotation of the media file at the operation 510 may include storing the information in the header 102 of the media file 100 (e.g., as the buffer checkpoint information 108) or otherwise storing or packaging the information for transmission prior to or along with the media file 100. In some embodiments of the process 500, the computing device 200 may perform the analysis of the operation 504 and proceed directly to the operation 510 to annotate the media file 100 with the identified buffer checkpoints. In such embodiments, the operations 506 and 508 may or may not be performed. A media file annotated with buffer checkpoints in accordance with any of the embodiments of the process 500 of FIG. 5 may be played back by a computing device (such as the computing device 200) configured to perform any of the embodiments of the process 300 of FIG. 3.

FIG. 6 depicts an illustrative display 600 that may be provided by the computing device 200 during annotation of the media file with buffer checkpoint information, in accordance with various embodiments. As discussed above with reference to FIG. 4, the display 600 may include a video or other image 602 associated with the media file 100, a playback indicator bar 610 including a current time indicator 612 to reflect the progress of playback of the media file 100, a current time/duration indicator 608, and a control bar 614 that may include one or more media control icons (e.g., play, stop, pause, and volume controls, for example). The display 600 may also include a buffer checkpoint indicator bar 604, which may provide one or more buffer checkpoint indicators 606. The buffer checkpoint indicators 606 may be positioned along the buffer checkpoint indicator bar 604 and aligned with various points on the playback indicator bar 610 to indicate the elapsed time points at which the media file 100 is to be annotated with buffer checkpoints.

The display 600 may also include a buffer checkpoints list 616. The buffer checkpoints list 616 may include one or more entries 618 corresponding to elapsed time points corresponding to selected buffer checkpoints with which the media file 100 may be annotated. The entries 618 may correspond with the buffer checkpoint indicators 606 positioned along the buffer checkpoint indicator bar 604. The buffer checkpoints list 616 may also include candidate buffer checkpoints 620 (e.g., previously entered by the creator but not selected, and/or identified by the computing device 200 as discussed above with reference to the operations 504 and 506 of FIG. 5 but not selected). These entries 618 may remain in the buffer checkpoints list 616 with one or more visually distinguishing characteristics (e.g., the use of italic text, greyed-out text, the lack of a “check mark” indicator), and may be represented as candidate buffer checkpoint indicators 628 positioned along the buffer checkpoint indicator bar 604, and may be subsequently selected for annotating the media file 100 or for deletion from the buffer checkpoints list 616. A number of blank entries 622 in the buffer checkpoints list may provide space for a creator to type in desired checkpoints. The blank entries 622 may also be populated by elapsed time points in response to the creator clicking, touching, or otherwise selecting a particular point along the buffer checkpoint indicator bar 604. An icon 624 may be selectable to allow the creator to clear all of the populated entries from the buffer checkpoints list 616. An icon 626 may be selectable to allow the creator to instruct the computing device 200 to annotate the media file 100 with buffer checkpoint information in accordance with the selected buffer checkpoints in the buffer checkpoints list 616.

Using the display 600, a creator can play back the media file 100 and identify natural pause points or other desired locations for the inclusion of buffer checkpoints. The techniques disclosed herein thus give creators an additional level of control over the user experience, allowing them to prevent the interruption of playback at sensitive moments (e.g., in the middle of a sentence of dialogue, the middle of a tense action scene, or just before the villain is about to be unmasked).

Computer readable media (including non-transitory computer readable media), methods, systems and devices for performing the above-described techniques are illustrative examples of embodiments disclosed herein. In some embodiments, such computer readable media may be included in the storage device 204 of the computing device 200 of FIG. 2. For example, the computational logic 222 of FIG. 2 may include assembler instructions supported by the processing device 202, or may include instructions in a high-level language, such as C, that can be compiled by the processing device 202. In some embodiments, a permanent copy of the computer readable instructions may be placed into permanent storage in the storage device 204 in the factory or in the field (through, for example, a machine-accessible distribution medium (not shown), such as a compact disc). In some embodiments, a permanent copy of the computer readable instructions may be placed into permanent storage in the storage device 204 through the communication interface 210 (e.g., from a distribution server (not shown)).

The following paragraphs provide a number of examples of embodiments of the present disclosure. Example 1 is a method for media playback, including: receiving information about a media file at a computing device, the information representative of one or more elapsed time points of a plurality of elapsed time points corresponding to buffer checkpoints in playback of the media file; determining, with the computing device, an amount of the media file that has been cached in a buffer on the computing device; determining, with the computing device, prior to commencing playback of a portion of the media file between a first of the elapsed time points and a second of the elapsed time points following the first elapsed time point, whether the amount of the media file cached in the buffer includes the portion of the media file; and in response to determining that the amount of the media file cached in the buffer does not include the portion of the media file, increasing, with the computing device, the amount of the media file cached in the buffer to include the portion of the media file before commencing playback of the portion of the media file.

Example 2 may include the subject matter of Example 1, and further includes: after increasing the amount of the media file cached in the buffer, determining, with the computing device, a second amount of the media file that has been cached in the buffer; determining, with the computing device, prior to commencing playback of the portion of the media file, whether the second amount of the media file cached in the buffer includes the portion of the media file; and in response to determining that the second amount of the media file cached in the buffer includes the portion of the media file, playing back the portion of the media file.

Example 3 may include the subject matter of Example 2, and further includes: in response to playing back the portion of the media file, determining, with the computing device, a third amount of the media file that has been cached in the buffer; determining, with the computing device, prior to commencing playback of a second portion of the media file between the second of the elapsed time points and a third of the elapsed time points following the first elapsed time point, whether the third amount of the media file cached in the buffer includes the second portion of the media file; and in response to determining that the third amount of the media file cached in the buffer does not include the second portion of the media file, pausing playback of the media file and increasing, with the computing device, the amount of the media file cached in the buffer to include the second portion of the media file before commencing playback of the second portion of the media file.

Example 4 may include the subject matter of any of Examples 1-3, and further specifies that the information about the media file is included in a header of the media file.

Example 5 may include the subject matter of any of Examples 1-4, and further specifies that the list representative of one or more elapsed time points includes a list of one or more timestamps.

Example 6 may include the subject matter of Example 2, and further includes displaying, on a display device during playback of the portion of the media file, one or more indicators representative of the one or more elapsed time points.

Example 7 is a method for media playback, including: providing, with a computing device, a media file; receiving, at the computing device, an input representative of a selection of one or more buffer checkpoints for the media file, the buffer checkpoints corresponding to one or more elapsed time points in playback of the media file; and annotating, by the computing device, the media file with information representative of the one or more elapsed time points in playback of the media file corresponding to the selected one or more buffer checkpoints, for use during playback of the media file.

Example 8 may include the subject matter of Example 7, and further specifies that annotating the media file with information representative of the one or more elapsed time points in playback of the media file corresponding to the selected one or more buffer checkpoints includes storing, in a header of the media file, the information representative of the one or more elapsed time points in playback of the media file corresponding to the selected one or more buffer checkpoints.

Example 9 may include the subject matter of any of Examples 7-8, and further includes: analyzing, with the computing device, an audio content or an image content of the media file to identify one or more candidate buffer checkpoints for the media file; and providing, on a display device, one or more indicators of the candidate buffer checkpoints for the media file.

Example 10 may include the subject matter of Example 9, and further specifies that receiving a user input representative of a selection of one or more buffer checkpoints for the media file includes receiving a user input representative of a selection of one or more of the indicators of the candidate buffer checkpoints.

Example 11 is an apparatus for media playback, including: a communication interface to receive information about a media file, the information representative of one or more elapsed time points of a plurality of elapsed time points corresponding to buffer checkpoints in playback of the media file; a storage device to hold a buffer; and a media player coupled to the communication interface and the storage device. The media player is to: determine an amount of the media file that has been cached in a buffer on the computing device, determine, prior to commencing playback of a portion of the media file between a first of the elapsed time points and a second of the elapsed time points following the first elapsed time point, whether the amount of the media file cached in the buffer includes the portion of the media file, and in response to determining that the amount of the media file cached in the buffer does not include the portion of the media file, increase the amount of the media file cached in the buffer to include the portion of the media file before commencing playback of the portion of the media file.

Example 12 may include the subject matter of Example 11, and further includes a display device. The media player is further to: after increasing the amount of the media file cached in the buffer, determine a second amount of the media file that has been cached in the buffer, determine, prior to commencing playback of the portion of the media file, whether the second amount of the media file cached in the buffer includes the portion of the media file; and in response to determining that the second amount of the media file cached in the buffer includes the portion of the media file, causing the playback of the portion of the media file on the display device.

Example 13 may include the subject matter of Example 12, and further specifies that the media player is further to: in response to playing back the portion of the media file, determine a third amount of the media file that has been cached in the buffer, determine, prior to commencing playback of a second portion of the media file between the second of the elapsed time points and a third of the elapsed time points following the first elapsed time point, whether the third amount of the media file cached in the buffer includes the second portion of the media file, and in response to determining that the third amount of the media file cached in the buffer does not include the second portion of the media file, cause the pausing of playback of the media file, and cause the increasing of the amount of the media file cached in the buffer to include the second portion of the media file before commencing playback of the second portion of the media file.

Example 14 may include the subject matter of any of Examples 11-13, and further specifies that the information about the media file is included in a header of the media file.

Example 15 may include the subject matter of any of Examples 11-14, and further specifies that the list representative of one or more elapsed time points in playback of the media file includes a list of one or more timestamp.

Example 16 may include the subject matter of Example 12, and further specifies that the media player is further to cause the display, during playback of the portion of the media file, of one or more indicators representative of the one or more elapsed time points.

Example 17 is an apparatus for media playback, including: an input device; a display device; a storage device to store a media file; and computational logic coupled to the input device, the display device and the storage device. The computational logic is to: provide the media file, from the storage device, for playback on the display device, receive an input, from the input device, representative of a selection of one or more buffer checkpoints for the media file, the buffer checkpoints corresponding to one or more elapsed time points in playback of the media file, and annotate the media file with information representative of the one or more elapsed time points in playback of the media file corresponding to the selected one or more buffer checkpoints.

Example 18 may include the subject matter of Example 17, and further specifies that annotate the media file with information representative of the one or more elapsed time points in playback of the media file corresponding to the selected one or more buffer checkpoints includes store, in a header of the media file on the storage device, the information representative of the one or more elapsed time points in playback of the media file corresponding to the selected one or more buffer checkpoints.

Example 19 may include the subject matter of any of Examples 17-18, and further specifies that the computational logic is to: analyze an audio content or an image content of the media file to identify one or more candidate buffer checkpoints for the media file, and provide, with the display device, one or more indicators of the candidate buffer checkpoints for the media file.

Example 20 may include the subject matter of Example 19, and further specifies that receive a user input representative of a selection of one or more buffer checkpoints for the media file includes receive a user input representative of a selection of one or more of the indicators of the suggested buffer checkpoints.

Example 21 is or more computer readable media having instructions thereon that, when executed by one or more processing devices of a computing device, cause the computing device to perform the method of any of Examples 1-10.

Example 22 is an apparatus including means for performing the method of any of Examples 1-10.

Example 23 is a system including: one or more processing devices; and one or more computer readable media having instructions thereon that, when executed by the one or more processing devices, cause the apparatus to perform the method of any of Examples 1-10.

Example 24 is at least one storage medium including a plurality of instructions configured to cause an apparatus, in response to execution of the instructions by the apparatus, to perform the method of any of Examples 1-10.

1-10. (canceled)

11. An apparatus for media playback, comprising:
a communication interface to receive information about a media file, the information representative of one or more elapsed time points of a plurality of elapsed time points corresponding to buffer checkpoints in playback of the media file;
a storage device to hold a buffer; and
a media player coupled to the communication interface and the storage device, the media player to:
determine an amount of the media file that has been cached in a buffer on the computing device,
determine, prior to commencing playback of a portion of the media file between a first of the elapsed time points and a second of the elapsed time points following the first elapsed time point, whether the amount of the media file cached in the buffer includes the portion of the media file, and
in response to determining that the amount of the media file cached in the buffer does not include the portion of the media file, increase the amount of the media file cached in the buffer to include the portion of the media file before commencing playback of the portion of the media file.

12. The apparatus of claim 11, further comprising:
a display device;
wherein the media player is further to:
after increasing the amount of the media file cached in the buffer, determine a second amount of the media file that has been cached in the buffer,
determine, prior to commencing playback of the portion of the media file, whether the second amount of the media file cached in the buffer includes the portion of the media file; and
in response to determining that the second amount of the media file cached in the buffer includes the portion of the media file, causing the playback of the portion of the media file on the display device.

13. The apparatus of claim 12, wherein the media player is further to:
in response to playing back the portion of the media file, determine a third amount of the media file that has been cached in the buffer,
determine, prior to commencing playback of a second portion of the media file between the second of the elapsed time points and a third of the elapsed time points following the first elapsed time point, whether the third amount of the media file cached in the buffer includes the second portion of the media file, and
in response to determining that the third amount of the media file cached in the buffer does not include the second portion of the media file,
cause the pausing of playback of the media file, and
cause the increasing of the amount of the media file cached in the buffer to include the second portion of the media file before commencing playback of the second portion of the media file.

14. The apparatus of claim 11, wherein the information about the media file is included in a header of the media file.

15. The apparatus of claim 11, wherein the list representative of one or more elapsed time points in playback of the media file comprises a list of one or more timestamp.

16. The apparatus of claim 12, wherein the media player is further to:
cause the display, during playback of the portion of the media file, of one or more indicators representative of the one or more elapsed time points.

17. An apparatus for media playback, comprising:
an input device;
a display device;
a storage device to store a media file; and
computational logic coupled to the input device, the display device and the storage device, the computational logic to:
provide the media file, from the storage device, for playback on the display device,
receive an input, from the input device, representative of a selection of one or more buffer checkpoints for the media file, the buffer checkpoints corresponding to one or more elapsed time points in playback of the media file, and
annotate the media file with information representative of the one or more elapsed time points in playback of the media file corresponding to the selected one or more buffer checkpoints.

18. The apparatus of claim 17, wherein annotate the media file with information representative of the one or more elapsed time points in playback of the media file corresponding to the selected one or more buffer checkpoints comprises store, in a header of the media file on the storage device, the information representative of the one or more elapsed time points in playback of the media file corresponding to the selected one or more buffer checkpoints.

19. The apparatus of claim 17, wherein the computational logic is further to:
analyze an audio content or an image content of the media file to identify one or more candidate buffer checkpoints for the media file, and
provide, with the display device, one or more indicators of the candidate buffer checkpoints for the media file.

20. The apparatus of claim 19, wherein receive a user input representative of a selection of one or more buffer checkpoints for the media file comprises receive a user input representative of a selection of one or more of the indicators of the suggested buffer checkpoints.

21-24. (canceled)

25. One or more computer readable media having instructions thereon that, when executed by one or more processing devices of a computing device, cause the computing device to:
receive information about a media file, the information representative of one or more elapsed time points of a plurality of elapsed time points corresponding to buffer checkpoints in playback of the media file;
determine an amount of the media file that has been cached in a buffer on the computing device;
determine, prior to commencing playback of a portion of the media file between a first of the elapsed time points and a second of the elapsed time points following the first elapsed time point, whether the amount of the media file cached in the buffer includes the portion of the media file; and
in response to determining that the amount of the media file cached in the buffer does not include the portion of the media file, increase the amount of the media file cached in the buffer to include the portion of the media file before commencing playback of the portion of the media file.

26. The one or more computer readable media of claim 25, further comprising instructions thereon that, when executed by the one or more processing devices, cause the computing device to:
after increasing the amount of the media file cached in the buffer, determine a second amount of the media file that has been cached in the buffer;
determine, prior to commencing playback of the portion of the media file, whether the second amount of the media file cached in the buffer includes the portion of the media file; and
in response to determining that the second amount of the media file cached in the buffer includes the portion of the media file, play back the portion of the media file.

27. The one or more computer readable media of claim 26, further comprising instructions thereon that, when executed by the one or more processing devices, cause the computing device to:
in response to playing back the portion of the media file, determine a third amount of the media file that has been cached in the buffer;
determine, prior to commencing playback of a second portion of the media file between the second of the elapsed time points and a third of the elapsed time points following the first elapsed time point, whether the third amount of the media file cached in the buffer includes the second portion of the media file; and
in response to determining that the third amount of the media file cached in the buffer does not include the second portion of the media file,
pause playback of the media file; and
increase the amount of the media file cached in the buffer to include the second portion of the media file before commencing playback of the second portion of the media file.

28. The one or more computer readable media of claim 25, wherein the information about the media file is included in a header of the media file.

29. The one or more computer readable media of claim 25, wherein the list representative of one or more elapsed time points comprises a list of one or more timestamps.

30. The one or more computer readable media of claim 26, further comprising instructions thereon that, when executed by the one or more processing devices, cause the computing device to:
causing the display, on a display device during playback of the portion of the media file, one or more indicators representative of the one or more elapsed time points.

31. One or more computer readable media having instructions thereon that, when executed by one or more processing devices of a computing device, cause the computing device to:
provide a media file;
receive an input representative of a selection of one or more buffer checkpoints for the media file, the buffer checkpoints corresponding to one or more elapsed time points in playback of the media file; and
annotate the media file with information representative of the one or more elapsed time points in playback of the media file corresponding to the selected one or more buffer checkpoints, for use during playback of the media file.

32. The one or more computer readable media of claim 31, wherein annotate the media file with information representative of the one or more elapsed time points in playback of the media file corresponding to the selected one or more buffer checkpoints comprises store, in a header of the media file, the information representative of the one or more elapsed time points in playback of the media file corresponding to the selected one or more buffer checkpoints.

33. The one or more computer readable media of claim 31, further comprising instructions thereon that, when executed by the one or more processing devices, cause the computing device to:
analyze an audio content or an image content of the media file to identify one or more candidate buffer checkpoints for the media file; and
provide, on a display device, one or more indicators of the candidate buffer checkpoints for the media file.

34. The one or more computer readable media of claim 33, wherein receive a user input representative of a selection of one or more buffer checkpoints for the media file comprises receive a user input representative of a selection of one or more of the indicators of the candidate buffer checkpoints.
